(19) United States
(12) Patent Application Publication
(10) Pub. No.: US 2004/0089032 A1
(43) Pub. Date: May 13, 2004

(54) Combination lock with dial displaying window

(76) Inventor: Renny Tse-Haw Ling, Chung-Ho City (TW)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/234,619

(22) Filed: Sep. 4, 2002

(51) Int. Cl. E05B 37/00

(52) U.S. Cl. 70/30

(57) ABSTRACT

A combination lock with a dial displaying window which is directed to a combination lock with the installation of a dial matching frame placed across all the dials and having at least one window for the users to check the combination numerals or symbols on the dials through the window for unlocking the combination lock. The dial matching frame may be differently constructed to provide the window with the displaying function. A magnification lens may be mounted on the window to further enhance the effectiveness during utilization.

### CROSS-REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention is related to a dial matching device for a combination lock, in particular, a dial matching device that helps the user to more accurately identify the corresponding locations of all the dials for unlocking the combination lock,

2. Description of the Related Art

A combination lock is a locking apparatus utilizing dials which must be adjusted to the pre-designated locations of preset numerals or symbols for unlocking the combination lock.

The conventional combination lock usually includes indication arrows, symbols, grooves or protrusions as the dial matching device, which is referred to as “dial matching indication unit” hereinafter, on one or both sides of the parallel dials of the combination lock to identify the locations for matching the dials with the combination. The user adjusts the dials of the combination lock to the locations for matching the dials with the preset combination with reference to the dial matching indication unit so as to unlock the combination lock. In other words, as long as each of the dials is accurately matched with the preset numeral or symbol at the location Indicated by the dial matching indication unit, the combination lock may be unlocked

Generally, the “dial matching indication unit” is provided only adjacent to the outermost dial(s), that is, only the outermost dial(s) may be directly identified by the adjacent dial matching indication unit. Nonetheless, the dials in the middle, or those not adjacent to the dial matching Indication unit, may still be checked by visually extending the identification direction pointed out by the dial matching indication unit, so that the user may complete the dial matching process. Such kind of dial matching indication unit has been used in the combination lock for a long time.

However, such a dial matching indication unit is not an ideal solution for the combination lock. Usually, the dial matching Indication unit is not very apparent to the user and thus, some drawbacks may occur. For example:

1. When the grooves or protrusions are used on the surface of the combination lock as the dial matching indication unit, if the depth or height thereof is too small, the visual effect for identification may not be significant enough; on the other hand, if the depth of the grooves is too large, dust may be accumulated therein; if the height of the protrusions is too large, they may appear awkward.

2. If the dial matching indication unit is printed on the surface of the lock or in the form of a sticker, they are easily damaged during the usage of the lock and may become unclear or even disappear and thus, the identification function thereof is deteriorated.

3. Even if a user knows that the designated combination number of the dials must exactly match with the indication unit in order to unlock the locks, combination locks usually allow a minute amount of displacement such that the locks still cannot be unlocked even if the indicating unit has pointed to the side edges of the designated combination number with excessive displacement.

### BRIEF SUMMARY OF THE INVENTION

A primary objective of this invention is to overcome the above drawbacks and provide a dial matching indication device for a combination lock to clearly mark the reference position for matching the dials, such that the user may quickly and accurately identify the combination of a series of numerals (or symbols) of the dials through the dial matching indication device for unlocking the combination lock. In addition, the dial matching identification function provided by the device of this invention will not be easily deteriorated by the usage of the lock.

According to the above objective, this invention provides a window-type dial matching identification mechanism, comprising a dial matching frame which is provided on a lock mechanism. The frame has at least one window placed across all the dials at a predetermined matching position, so that the user can quickly and accurately identify the combination of the dials through the window for unlocking the lock.

The structures and characteristics of this invention can be realized by referring to the appended drawings and explanations of the preferred embodiments.

### BRIEF DESCRIPTION OF THE DRAWINGS

FIG. 1 is a schematic view showing one of the preferred embodiments according to this invention;

FIG. 2 is an exploded view showing the structure of the embodiment of FIG. 1;

FIG. 3 is a top plan view showing the structure of the embodiment of FIG. 1;

FIG. 4 is a schematic view showing another preferred embodiment according to this invention;

FIGS. 5A and 5B show the possible structures of the dial matching frames utilized in the preferred embodiments for a combination lock;

FIG. 6 is another type of the dial matching frame utilized in the preferred embodiment of this Invention;

FIG. 7 is a schematic view showing yet another preferred embodiment according to this invention;

FIG. 8 is a schematic view showing a further preferred embodiment according to this Invention;

FIG. 9 is a schematic assembly view showing the embodiment of FIG. 8;

FIG. 10 is a schematic view showing a further preferred embodiment according to this invention; and

FIG. 11 is a schematic view showing the other preferred embodiment according to this invention,

### DETAILED DESCRIPTION OF THE INVENTION

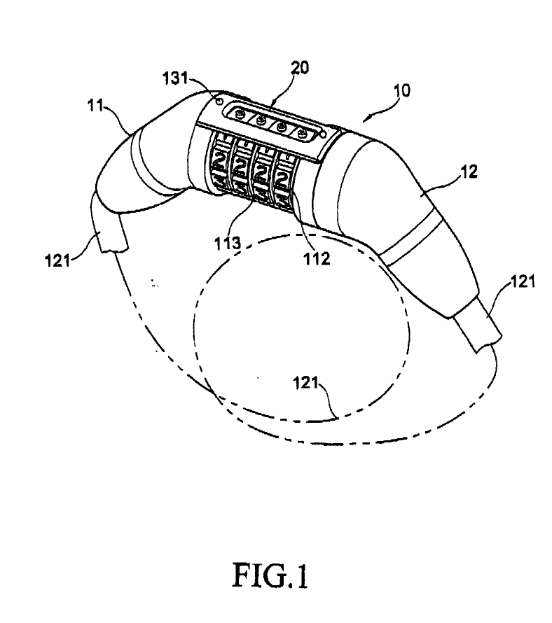

FIG. 1 shows a combination lock 10 with a dial matching frame 20 thereon such that the user can clearly identify the combination of the dials for unlocking the lock. As illustrated in the figures, the combination lock 10 includes a lock body 11 and a latch 12, wherein the lock body 11 further has a locking hole 111 and a plurality of parallel dials 112 provided around the exterior of the lock body 11. Each of the dials 112 can be Independently rotated with respect to the lock body 11 and is provided with numerals 113 (or symbols) surrounding the surface thereof. When each of the dials 112 is rotated to a preset combination at the predetermined dial matching position, the lock body 11 may be unlocked. Otherwise, when one or more numerals 113 of the dials 112 at the matching position do not match with the preset combination, the lock body 11 remains at the locked state. The application of this kind of combination lock 10 is well known to the persons skilled in the art and thus, the detailed description is not provided.

The combination lock 10 also includes a latch 12. According to this invention, the latch 12 may be a U-shaped rigid body or a flexible wire, such as a steel cable. In the preferred embodiments discussed in this invention, the latch 12 includes a steel cable 121 having a desired length with one end thereof connected with the lock body 11, and the other end of the latch 12 is provided with a locking rod 122 which may be inserted into the locking hole 111 to be locked by the lock body 11 when it is adjusted to the locked state. Thus, the lock body 11 and the latch 12 are locked together and form a closed loop. Of course, the locking rod 122 may be released from the locking hole 111 when the lock body 11 is at the unlocked state,

In addition to the lock body 11 and the latch 12, the combination lock 10 disclosed in the preferred embodiment of this invention further comprises a dial matching frame 20 which is used to provide the reference position and enhance the identifiability for the user to match the dials 112. Accordingly, the user can clearly identify a set of numerals 113 on the dials 112 through the dial matching frame 20. Generally, the dial matching frame 20 includes a frame body 21 which defines at least one window 22 enclosed by an appropriate perimeter.

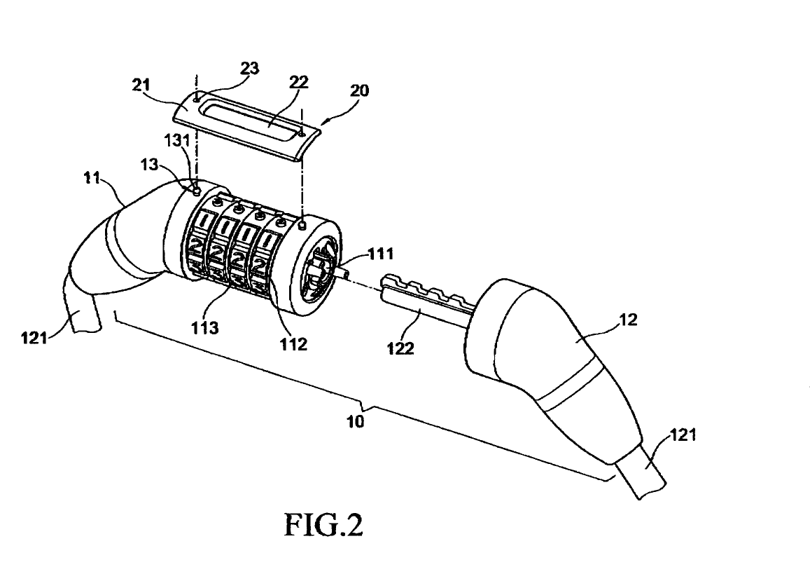

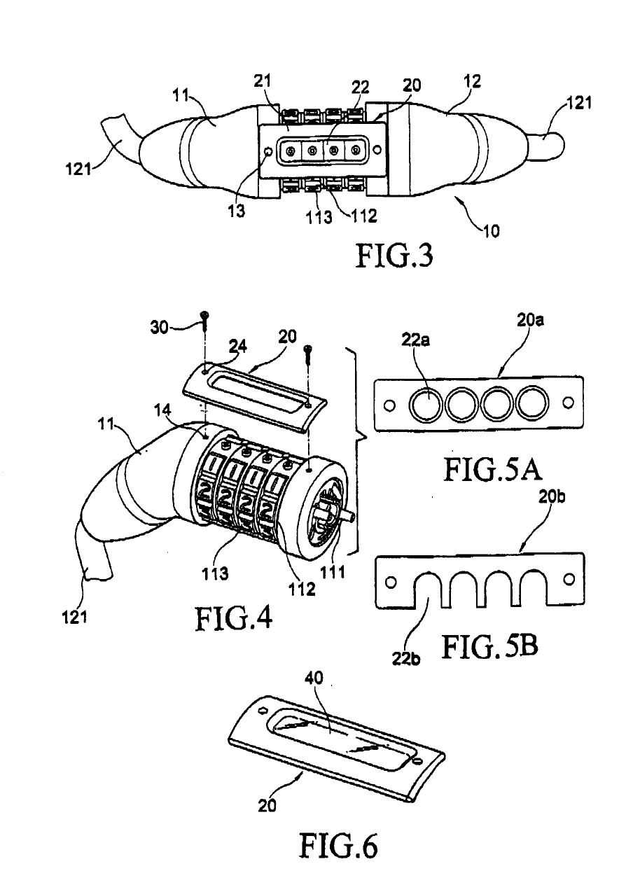

As illustrated in FIGS. 2 and 3, after the dial matching frame 20 is mounted on the lock body 11 (to be further described later), the numerals 113 can be clearly identified by the user through the window 22. The size of the window 22 can be appropriately designed in view of the dimension of the numerals 113 on the dials 112, such that under normal viewing angle, the user can only see one set of the numerals 113 on the dials 112. That is, only the set of numerals 113 adjusted to the matching position can be seen through the window 22.

In the preferred embodiments of this invention, the dial matching frame 20 and the lock body 11 may be separable components, wherein the dial matching frame 20 and the lock body 11 respectively have mating holes 23 and mating blocks 13 of the same number at corresponding locations such that the dial matching frame 20 can be mounted on the lock body 11 by inserting the mating blocks 13 into the mating holes 23. In actual application, the mating block 13 may further incorporate a resilient head 131 which is deformable upon an external force for passing through the mating hole 23, so that the dial matching frame 20 can be mounted on the lock body 11.

As shown in FIG. 4, each of the dial matching frame 20 and the lock body 11 may have a fastening hole 14 and 24, respectively, at a corresponding location, and a fastening member 30 is further provided to pass through the two fastening holes 14 and 24 so as to fasten the dial matching frame 20 on the lock body 11.

FIGS. 5A and 5B show the dial matching frames 20a and 20b with different structures as compared with that disclosed in FIG. 3. As shown in FIG. 5A, the dial matching frame 20a has small windows 22a on its surface in the same number with that of the dials 112. Each of the small windows 22a is designed according to the type and size of the numerals 113, and may also be designed into various shapes to present unique and novel visual effects. In FIG. 5A, the small windows 22a are round, and of course may be other geometrical shapes or specially designed shapes. Further, as illustrated in FIG. 5B, instead of the enclosed circular shape shown In FIG. 5A, the small windows of the dial matching frame 20b may be in the form of a semicircular opening 22b. Although the dial matching frame 20b with the opening 22b may not completely encircle the numerals 113, the numerals 113 of the dials 112 at the dial matching position can still be clearly identified in such a design.

In view of the above, it is understood that the dial matching frame 20, 20a or 20b is a dial displayer provided on the combination lock 10 so as to facilitate the user to match the combination of the lock 10. The dial matching frame 20, 20a or 20b should have at least one displaying window 22, 22a or opening 22b. The dial matching frame 20 may further include a lens 40 Inserted thereinto, as shown in FIG. 6. Particular, the lens 40 may be a convex lens to magnify the numerals 113 through the window 22. Moreover, the dial matching frame 20 may be made of a fluorescent material such that the combination lock 10 can still be used in a dark environment since the display of the numerals 113 are enhanced by the light emitting from the dial matching frame 20.

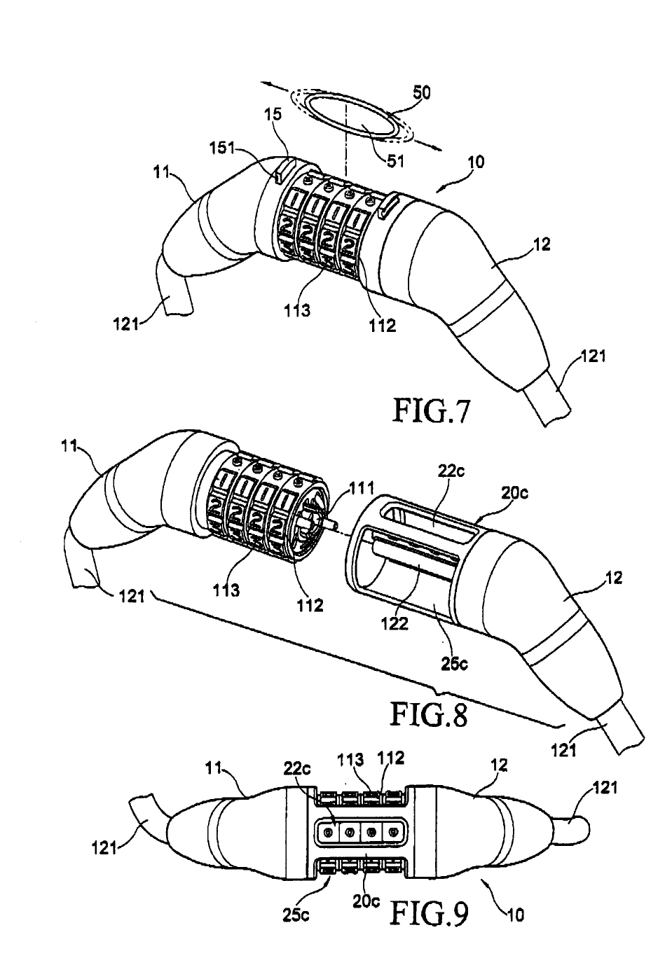

FIG. 7 shows another type structure of the dial matching frame 20. As illustrated in the drawing, the dial matching identification mechanism may be a resilient member 50 with restorability after stretching. In addition, the lock body 11 has two positioning parts 15 at the predetermined dial matching positions on both sides of the dials 112, respectively. The resilient member 50 is stretched and wrapped around the positioning parts 15. The resilient member 50 thus forms a frame body surrounding the dial matching position and defines a window 51 to provide the indication function. In order to have stable attachment so that the resilient member 50 will not be easily or unexpectedly separated from the positioning parts 15, the resilient member 50 should have shorter length than the distance between the two positioning parts 15. Therefore, the resilient member 50 must be properly stretched prior to being wrapped around the positioning parts 15 and thus, the resilient member 50 is constantly under the recovering force and is stably engaged with the positioning parts 15. Furthermore, the positioning parts 15 may comprise recessed grooves 151 so that the resilient member 50 can be inserted thereinto and will not be separated very easily.

Accordingly, not only the dial matching frame 20 made of hard material can provide the user with dial matching function for the combination lock 10, the resilient member 50 with restorability after stretching may also be used to achieve the identical function.

FIG. 8 discloses another preferred embodiment of this invention. The latch 12 has an integrally formed dial matching frame 20c. The latch 12 also includes the steel cable 121 with one end thereof connected with the lock body 11. The other end of the latch 12 is provided with the locking rod 122 which may be inserted into the locking hole 111 to be locked by the lock body 11 when it is adjusted to the locked state. At this time, the latch 12 is fixed with the lock body 11. The locking rod 122 may be released from the locking hole 111 when It is at the unlocked state.

Alternatively, the dial matching frame 20c may be integrally formed with the lock body 11. In either way, the window 22c of the dial matching frame 20c is set to be at the dial matching position above the dials 112 when the locking rod 122 is inserted into and locked within the locking hole 111, as shown in FIG. 9. The dial matching frame 20c may be constructed as that shown in the figure as an annular framework surrounding the latch 12. The dial matching frame 20c has not only an engraved window 22c, but also dialing holes 25c for the user to rotate the dials 112.

This kind of dial matching frame 20c provides the function of identifying the matching position of the dials for the user through the window 22c, it also provides certain degree of protection over the latch 12 to prevent damage thereto due to collision between the latch 12 and other articles.

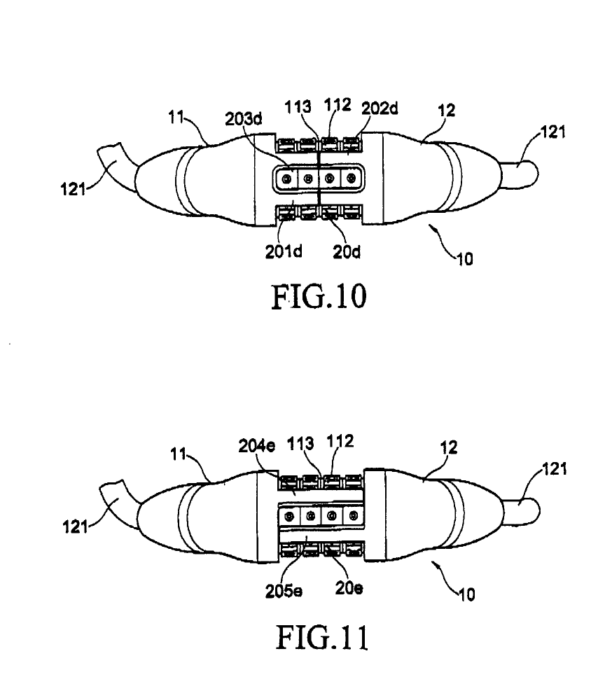

FIG. 10 illustrates another type of preferred embodiment for a dial matching frame 20d according to this invention. The overall dial matching frame 20d is not solely extended from the lock body 11 or the latch 12, but combined by two half frames 201d, 202d extending from the lock body 11 and the latch 12 respectively. Thus, when the locking rod 122 is inserted into the locking hole 111, the two half frames 201d and 202d match with each other above and is placed across all the dials 112 at the predetermined dial matching position and form at least one window 203d above the dials 112 in order to show the numerals 113 thereon.

In other words, the dial matching frame 20d is formed by two concave plates extending toward each other from the lock body 11 and the latch 12 respectively. It is not integrally formed in one piece.

FIG. 11 discloses a modified structure based on the previous preferred embodiment. The dial matching frame 20e is formed by two straight plates 204e and 205e extending from the lock body 11 and the latch 12 respectively and misaligned with each other.

It should be pointed out that, the lens inserted into the dial matching frame as shown in FIG. 6 and the use of a fluorescent material to make the dial matching frame, may also be applied to the dial matching frames 20c, 20d as shown In FIGS. 8 and 10 so as to enhance the displaying effects of the combination numerals.

This invention provides a dial matching frame to be utilized on a combination lock. It is a dial matching indication device that clearly marks the reference position for matching the dials. Therefore, the user may quickly and accurately Identify the combination of a series of numerals (or symbols) of the dials through the dial matching indication device for unlocking the combination lock. In addition, the dial matching identification function provided by the device of this invention will not be easily deteriorated by the usage of the lock.

This Invention is related to a novel creation that makes a breakthrough in the art. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

### Sequence Listing

10 combination lock

11 lock body

111 locking hole

112 dials

113 numerals

12 latch

121 steel cable

122 locking rod

13 mating blocks

14 fastening holes

15 positioning parts

151 recessed grooves

20 dial matching frame

20a dial matching frame

20b dial matching frame

20c dial matching frame

20d dial matching frame

20e dial matching frame

201d half frame

203d window

204e straight plate

205e straight plate

21 frame body

22 window

22a window

22b opening

22c window

23 mating holes

24 fastening hole

25c dialing holes

30 fastening member

40 lens

50 resilient member

1. A combination lock with a dial displaying window, comprising:
a lock mechanism having a locking hole and a plurality of adjacent dials in parallel, wherein the lock mechanism is convertible between an unlocked state and a locked state by rotating the dials;
a latch, having one end connected with the lock mechanism and another end to be inserted into the locking hole, such that the latch is adapted to be locked by the lock mechanism when it is at the locked state, and the latch is adapted to be removed from the locking hole when the lock mechanism is at the unlocked state; and
a dial matching frame which is releasably provided on the lock mechanism and is placed across all the dials at a predetermined matching position, wherein the dial matching frame has at least one window.

2. The combination lock with a dial displaying window according to claim 1, wherein the dial matching frame and the lock mechanism respectively have mating holes and mating blocks of the same number at corresponding locations such that the dial display frame is mounted on the lock mechanism by inserting the mating blocks into the mating holes.

3. The combination lock with a dial displaying window according to claim 2, wherein each of the mating blocks has a resilient head which is deformable for passing through the mating hole.

4. The combination lock with a dial displaying window according to claim 1, wherein each of the dial matching frame and the lock mechanism have a fastening hole respectively at a corresponding location, and a fastening member is further provided to pass through the two fastening holes so as to fasten the dial matching frame and the lock mechanism together.

5. The combination lock with a dial displaying window according to claim 1, wherein the at least one window is further inserted thereinto a transparent lens.

6. The combination lock with a dial displaying window according to claim 5, wherein the transparent lens is a convex lens.

7. The combination lock with a dial displaying window according to claim 1, wherein the frame is provided with a plurality of windows that are at the same number of the dials.

8. The combination lock with a dial displaying window according to claim 1, wherein the frame is made of a fluorescent material.

9. The combination lock with a dial displaying window according to claim 1, wherein he at least one window includes a closed hole provided on the frame.

10. The combination lock with a dial displaying window according to claim 1, wherein the at least one window includes an opening provided on the frame.

11. A combination lock with a dial displaying window, comprising:
a lock mechanism having a locking hole, a plurality of adjacent dials in parallel, and two positioning parts provided at opposing sides of the dials, wherein the lock mechanism is convertible between an unlocked state and a locked state by rotating the dials;
a latch, having one end connected with the lock mechanism and another end to be inserted into the locking hole, such that the latch is adapted to be locked by the lock mechanism when it is at the locked state, and the latch is adapted to be removed from the locking hole when the lock mechanism is at the unlocked state; and
a resilient member with restorability after stretching, wherein the resilient member is stretched across all the dials and is supported on the two positioning parts so as to define at least one window.

12. The combination lock with a dial displaying window according to claim 11, wherein the resilient member is a closed loop.

13. The combination lock with a dial displaying window according to claim 11, wherein the positioning part has a recessed groove for receiving the resilient member.

14. A combination lock with a dial displaying window, comprising:
a lock mechanism having a locking hole and a plurality of adjacent dials, wherein the lock mechanism is convertible between an unlocked state and a locked state by rotating the dials;
a latch, having one end connected with the lock mechanism and another end to be inserted into the locking hole, such that the latch is adapted to be locked by the lock mechanism when it is at the locked state, and the latch is adapted to be removed from the locking hole when the lock mechanism is at the unlocked state; and
a dial matching frame connected with one free end of the latch, such that when the free end of the latch is Inserted into the locking hole, the dial matching frame is placed across all the dials, wherein the dial matching frame has at least one window at a predetermined matching position over the dials.

15. The combination lock with a dial displaying window according to claim 14, wherein the at least one window is an engraved region.

16. The combination lock with a dial displaying window according to claim 14, wherein the dial matching frame is an annular framework surrounding the latch and further comprises dialing holes.

17. The combination lock with a dial displaying window, according to claim 14, wherein the at least one window is further inserted thereinto a transparent lens.

18. A combination lock with a dial displaying window, comprising:
a lock mechanism having a locking hole and a plurality of adjacent dials In parallel, wherein the lock mechanism is convertible between an unlocked state and a locked state by rotating the dials;
a latch, having one end connected with the lock mechanism and another end to be Inserted Into the locking hole, such that the latch is adapted to be locked by the lock mechanism when it is at the locked state, and the latch is adapted to be removed from the locking hole when the lock mechanism is at the unlocked state; and
a dial matching frame, including two half frames with one of them connected with one free end of the lock mechanism and the other connected with one free end of the latch, respectively, such that when the free end of the latch is inserted into the locking hole, the two half frames together are placed across all the dials at a predetermined matching position, wherein the two half frames form at least one window.

19. The combination lock with a dial displaying window according to claim 18, wherein the two half frames include plates extending from the lock mechanism and the latch respectively and matching with each other.

20. The combination lock with a dial displaying window according to claim 18, wherein each of the two half frames includes a straight plate extending from the lock mechanism and the latch respectively and misaligned with each other.
